(19) United States
(12) Patent Application Publication
(10) Pub. No.: US 2024/0343261 A1
(43) Pub. Date: Oct. 17, 2024

(54) APPLICATIONS OF SHEPARD TONE IN VEHICLE SOUND DESIGN

(71) Applicant: GM GLOBAL TECHNOLOGY OPERATIONS LLC, Detroit, MI (US)

(72) Inventors: Orson S Wang, Northville, MI (US); Yael Shmueli Friedland; Jigar Kapadia, Bloomfield Hills, MI (US)

(73) Assignee: GM GLOBAL TECHNOLOGY OPERATIONS LLC, Detroit, MI (US)

(21) Appl. No.: 18/298,643

(22) Filed: Apr. 11, 2023

(51) Int. Cl. B60W 50/14; B60Q 5/00; B60Q 9/00; B60W 60/00; G10K 15/02; H04R 1/02; H04R 3/00

(52) U.S. Cl. CPC B60W 50/14; B60Q 5/00; B60Q 9/00; B60W 60/005; G10K 15/02; H04R 1/025; H04R 3/00; H04R 2499/13

(57) ABSTRACT

Methods and systems are provided that include one or more sensors configured to obtain sensor data for a vehicle; and a processor that is coupled to the one or more sensors and that is configured to at least facilitate: determining a selected Shepard tone for a sound to be provided for the vehicle based on the sensor data; and providing the sound for the vehicle, using the selected Shepard tone, via one or more speakers of the vehicle in accordance with instructions provided by the processor.

### TECHNICAL FIELD

The technical field generally relates to vehicles and, more specifically, to systems and methods for controlling sound provided by vehicles.

### BACKGROUND

Certain vehicles today have systems that provide sounds for users of the vehicle, for example that may serve as an indication of how the vehicle is operating. However, existing techniques may not always provide optimal sounds for users of the vehicle and/or for others.

Accordingly, it is desirable to provide improved methods and systems for providing sounds for a vehicle. Furthermore, other desirable features and characteristics of the present invention will become apparent from the subsequent detailed description of the invention and the appended claims, taken in conjunction with the accompanying drawings and this background of the invention.

### SUMMARY

In an exemplary embodiment, a method is provided that includes: obtaining sensor data for a vehicle from one or more sensors of the vehicle; determining, via a processor of the vehicle, a selected Shepard tone for a sound to be provided for the vehicle based on the sensor data; and providing the sound for the vehicle, using the selected Shepard tone, via one or more speakers of the vehicle in accordance with instructions provided by the processor.

Also in an exemplary embodiment, the step of obtaining the sensor data includes obtaining the sensor data as to an acceleration of the vehicle, from the one or more sensors of the vehicle; and the step of determining the selected Shepard tone includes determining, via the processor, the selected Shepard tone for the sound to be provided for the vehicle based on the acceleration of the vehicle.

Also in an exemplary embodiment, the selected Shepard tone is determined via the processor such that a perception of acceleration for the vehicle is provided that is greater than or less than an actual acceleration of the vehicle when the vehicle is accelerating.

Also in an exemplary embodiment, the selected Shepard tone is determined via the processor that a perception of deceleration for the vehicle is provided that is less than or greater than an actual deceleration of the vehicle when the vehicle is decelerating.

Also in an exemplary embodiment, the step of determining the selected Shepard tone includes: determining, via the processor, a first selected Shepard tone that influences a behavior of a driver inside the vehicle, provides comfort for one or more passengers inside the vehicle, or both; and determining, via the processor, a second selected Shepard tone that provides comfort for one or more pedestrians outside the vehicle; and the step of providing the sound includes: providing an interior sound for the vehicle using the first selected Shepard tone, via one or more interior speakers of the vehicle in accordance with first instructions provided by the processor; and providing an exterior sound for the vehicle using the second selected Shepard tone, via one or more exterior speakers of the vehicle in accordance with second instructions provided by the processor.

Also in an exemplary embodiment, the method further includes determining, via the processor, a mode of operation for the vehicle using the sensor data, wherein the mode of operation includes either a standard mode of operation or a sport mode of operation for the vehicle; wherein the step of determining the selected Shepard tone includes determining, via the processor, the selected Shepard tone for the sound to be provided for the vehicle based on the mode of operation of the vehicle, and wherein a different selected Shepard tone is selected based on whether the mode of operation includes the sport mode of operation versus the standard mode of operation.

Also in an exemplary embodiment, the method further includes determining, via the processor, a mode of operation for the vehicle using the sensor data, wherein the mode of operation includes either an autonomous mode of operation or a manual mode of operation for the vehicle; wherein the step of determining the selected Shepard tone includes determining, via the processor, the selected Shepard tone for the sound to be provided for the vehicle based on the mode of operation of the vehicle, and wherein a different selected Shepard tone is selected based on whether the mode of operation includes the autonomous mode of operation versus the manual mode of operation.

Also in an exemplary embodiment, the step of obtaining the sensor data includes obtaining the sensor data as to a motor torque for the vehicle; wherein the step of determining the selected Shepard tone includes determining, via the processor, the selected Shepard tone for the sound to be provided for the vehicle based on the motor torque.

Also in an exemplary embodiment, the step of obtaining the sensor data includes obtaining the sensor data as to one or more conditions of caution surrounding the vehicle, including a construction zone, a school zone, or an approaching ambulance; wherein the step of determining the selected Shepard tone includes determining, via the processor, the selected Shepard tone for the sound to be provided for the vehicle based on the one or more conditions of caution surrounding the vehicle.

In another exemplary embodiment, a system is provided that includes one or more sensors configured to obtain sensor data for a vehicle; and a processor that is coupled to the one or more sensors and that is configured to at least facilitate: determining a selected Shepard tone for a sound to be provided for the vehicle based on the sensor data; and providing the sound for the vehicle, using the selected Shepard tone, via one or more speakers of the vehicle in accordance with instructions provided by the processor.

Also in an exemplary embodiment, the one or more sensors are configured to obtain the sensor data as to an acceleration of the vehicle; and the processor is further configured to at least facilitate determining the selected Shepard tone for the sound to be provided for the vehicle based on the acceleration of the vehicle.

Also in an exemplary embodiment, the processor is configured to at least facilitate determining the selected Shepard tone such that a perception of acceleration for the vehicle is provided that is greater than or less than an actual acceleration of the vehicle when the vehicle is accelerating.

Also in an exemplary embodiment, the processor is configured to at least facilitate determining the selected Shepard tone such that a perception of deceleration for the vehicle is provided that is less than or greater than an actual deceleration of the vehicle when the vehicle is decelerating.

Also in an exemplary embodiment, the processor is further configured to at least facilitate: determining a first selected Shepard tone that influences a behavior of a driver inside the vehicle, provides comfort for one or more passengers inside the vehicle, or both; determining a second selected Shepard tone provides comfort for one or more pedestrians outside the vehicle; providing an interior sound for the vehicle using the first selected Shepard tone, via one or more interior speakers of the vehicle in accordance with first instructions provided by the processor; and providing an exterior sound for the vehicle using the second selected Shepard tone, via one or more exterior speakers of the vehicle in accordance with second instructions provided by the processor.

Also in an exemplary embodiment, the processor is further configured to at least facilitate determining a mode of operation for the vehicle using the sensor data, wherein the mode of operation includes either a standard mode of operation or a sport mode of operation for the vehicle; and determining the selected Shepard tone for the sound to be provided for the vehicle based on the mode of operation of the vehicle, and wherein a different selected Shepard tone is selected based on whether the mode of operation includes the sport mode of operation versus the standard mode of operation.

Also in an exemplary embodiment, the processor is further configured to at least facilitate determining a mode of operation for the vehicle using the sensor data, wherein the mode of operation includes either an autonomous mode of operation or a manual mode of operation for the vehicle; and determining the selected Shepard tone for the sound to be provided for the vehicle based on the mode of operation of the vehicle, and wherein a different selected Shepard tone is selected based on whether the mode of operation includes the autonomous mode of operation versus the manual mode of operation.

Also in an exemplary embodiment, the one or more sensors are configured to obtain the sensor data as to a motor torque for the vehicle; and the processor is further configured to at least facilitate determining the selected Shepard tone for the sound to be provided for the vehicle based on the motor torque for the vehicle.

Also in an exemplary embodiment, the one or more sensors are configured to obtain the sensor data as to one or more conditions of caution surrounding the vehicle, including a construction zone, a school zone, or an approaching ambulance; and the processor is further configured to at least facilitate determining the selected Shepard tone for the sound to be provided for the vehicle based on the one or more conditions of caution surrounding the vehicle.

In another exemplary embodiment, a vehicle is provided that includes a body; a drive system configured to generate movement of the body; one or more sensors disposed on or within the body and configured to obtain sensor data for the vehicle; one or more speakers disposed on or within the body and configured to provide a sound for the vehicle; and a processor that is disposed within the body, that is coupled to the one or more sensors and to the one or more speakers, and that is configured to at least facilitate: determining a selected Shepard tone for the sound to be provided for the vehicle based on the sensor data; and providing instructions to the one or more speakers to provide the sound for the vehicle using the selected Shepard tone.

Also in an exemplary embodiment, the one or more sensors are configured to obtain the sensor data as to an acceleration of the vehicle; and the processor is further configured to at least facilitate determining the selected Shepard tone for the sound to be provided for the vehicle based on the acceleration of the vehicle.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle having a control system for controlling sounds for the vehicle using Shepard tones, in accordance with exemplary embodiments;

FIG. 2 is a flowchart of a process for controlling sounds for the vehicle using Shepard tones, in accordance with exemplary embodiments; and

FIGS. 3-16 illustrate exemplary implementations of the process of FIG. 2, and that can be implemented in connection with the vehicle of FIG. 1, including the control system and components thereof, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

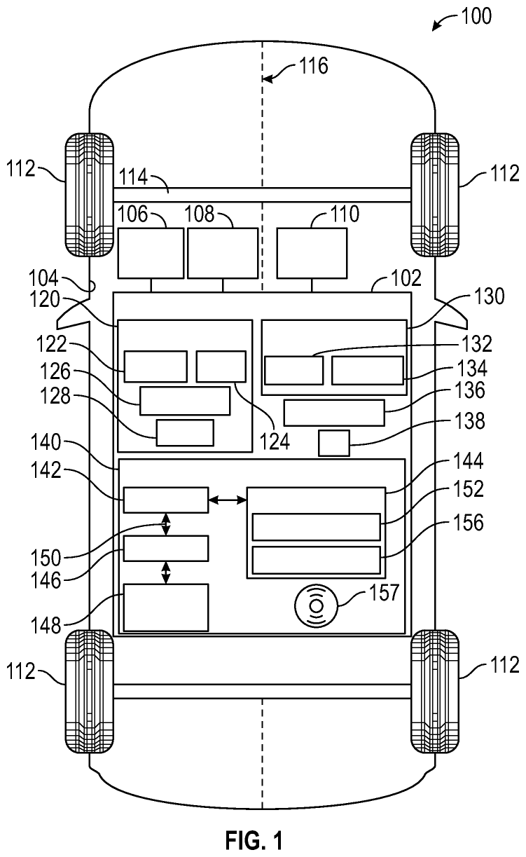

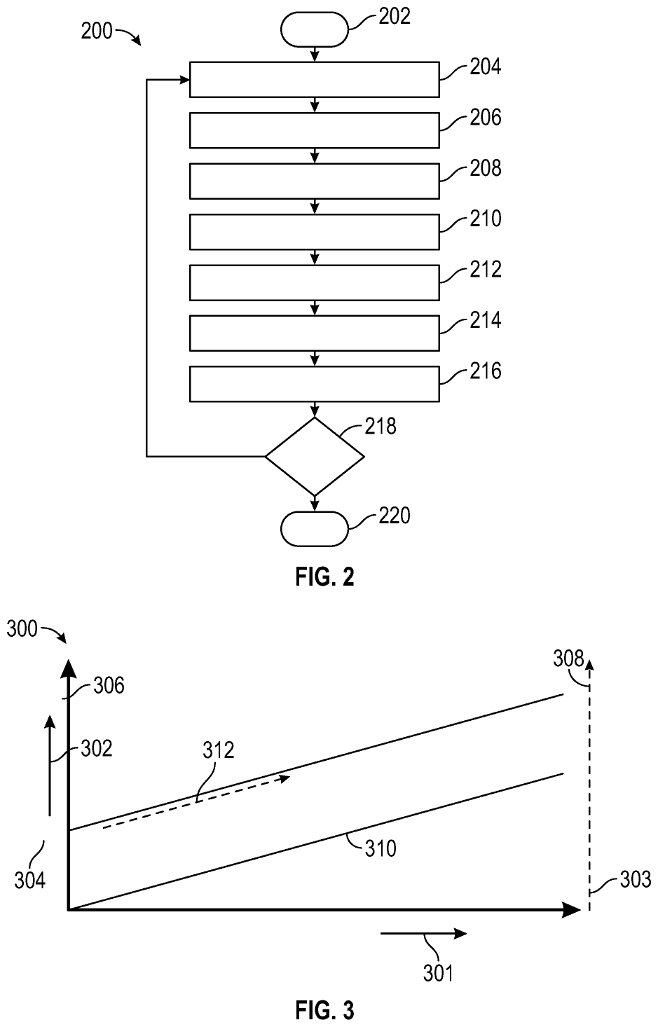

FIG. 1 illustrates a vehicle 100. In various embodiments, and as described below, the vehicle 100 includes a control system 102 for controlling sounds for the vehicle 100 using Shepard tones, in accordance with an exemplary embodiment. In various embodiments, the control system 102 utilizes Shepard tones for generating sounds both for individuals inside the vehicle 100 and for individuals outside the vehicle 100, including for serving as an indication for how the vehicle 100 is operating and for facilitating desired behavior or comfort for such individuals, for example as set forth in greater detail in the process of FIG. 2, the implementations of FIGS. 3-13, and the descriptions provided herein.

As used herein and as commonly understood, the term “Shepard tone” refers to a sound that includes a superposition of sine waves (or other sound sources, such as musical instruments) that are separated by octaves (or half octaves or quarter octaves, and so on), and that creates an auditory illusion of atone that appears to be continually ascending or descending in pitch when played with the pitch of the tone moving upward or downward.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

In certain embodiments, the vehicle 100 may comprise one or more different types of electric vehicles, such as a fully electric vehicle or a hybrid electric vehicle. However, this may vary in other embodiments, for example in which the vehicle 100 may be powered via gas combustion, solar power, and/or one or more other types of power sources.

In certain embodiments, the vehicle 100 may comprise an autonomous or semi-autonomous vehicle, for example in which vehicle control (including acceleration, deceleration, braking, and/or steering) is automatically planned and executed by the control system 102, in whole or in part. In certain other embodiments, the vehicle 100 may be operated in whole or in part by a human driver.

In the depicted embodiment, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks and certain other vehicles).

A drive system 110 is mounted on the chassis 116, and drives the wheels 112, for example via axles 114. The drive system 110 preferably comprises a propulsion system. In certain exemplary embodiments, the drive system 110 comprises an internal combustion engine and/or an electric motor/generator, coupled with a transmission thereof. In certain embodiments, the drive system 110 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As noted above, in certain embodiments, the vehicle 100 includes one or more functions controlled automatically via the control system 102. In certain embodiments, the vehicle 100 comprises an autonomous vehicle, such as a semi-autonomous vehicle or a fully autonomous vehicle, for automated control of the drive system 110 and/or other vehicle components. However, this may vary in other embodiments, for example in which a human driver may control the drive system 110.

As depicted in FIG. 1, the vehicle 100 also includes a braking system 106 and a steering system 108 in various embodiments. In exemplary embodiments, the braking system 106 controls braking of the vehicle 100 using braking components that are controlled via inputs provided by a driver (e.g., via a braking pedal in certain embodiments) and/or automatically via the control system 102. Also in exemplary embodiments, the steering system 108 controls steering of the vehicle 100 via steering components (e.g., a steering column coupled to the axles 114 and/or the wheels 112) that are controlled via inputs provided by a driver (e.g., via a steering wheel in certain embodiments) and/or automatically via the control system 102.

In the embodiment depicted in FIG. 1, in certain embodiments, the control system 102 is coupled to the braking system 106, the steering system 108, and the drive system 110.

Also as depicted in FIG. 1, in various embodiments, the control system 102 includes a sensor array 120, a speaker array 130, a navigation system 136, a transceiver 138, and a controller 140.

In various embodiments, the sensor array 120 includes various sensors that collect sensor data, including for use by the control system 102 in controlling sounds for the vehicle 100 using Shepard tones. As depicted in FIG. 1, in various embodiments the sensor array 120 includes one or more speed sensors 122, input sensors 124, and detection sensors 126. Also in various embodiments as depicted in FIG. 1, the sensor array 120 may also include one or more other sensors 128.

In various embodiments, the speed sensors 122 measure a speed of the vehicle 100 and/or values that are used to determine or estimate the speed. In certain embodiments, the speed sensors 122 include one or more wheel speed sensors for the vehicle 100. In other embodiments, one or more other types of speed sensors 122 may be utilized.

In various embodiments, the input sensors 124 detect inputs from a user of the vehicle 100 (e.g., from a driver or other individual inside the vehicle 100). In certain embodiments, the input sensors 124 detect user inputs as to a selection of or between various different operating modes of the vehicle, such as a standard driving mode versus sport driving mode, and/or between a manual driving mode versus an autonomous or semi-autonomous driving mode, and so on. In various embodiments, the input sensors 124 may detect the user inputs via the user's engagement of any number of different types of user input devices, such as via one or more touch screens, buttons, knobs, dials, switches, joysticks, microphones, and so on.

In various embodiments, the detection sensors 126 detect surrounding conditions for the vehicle 100, such as a roadway or path on which the vehicle 100 is located or is travelling and other vehicles and other objects on, along, or nearby the roadway or path, and so on. In various embodiments, the detection sensors 126 may include any number of different types of cameras, radar, Lidar, sonar, and/or other different types of sensors.

In various embodiments, the other sensors 128 obtain sensor data as to other measures of operation of the vehicle 100 and/or its environment that may also affect the desired sounds produced by the control system 102. In certain embodiments, the other sensors 128 may include one or more vehicle accelerometers, motor torque sensors, accelerator pedal position sensors, brake pedal position sensors, steering angle sensors, and/or any number of other different types of sensors.

In various embodiments, the speaker array 130 provides sound for the vehicle 100, using Shepard tones in accordance with instructions provided by the controller 140. In various embodiments, the speaker array 130 includes both inside speakers 132 (for providing of Shepard tone exterior sounds for individuals inside the vehicle 100) as well as outside speakers 134 (for providing of Shepard tone interior sounds for individuals outside the vehicle 100).

Also in various embodiments, the navigation system 136 (also referred to herein as a “location system”) is configured to obtain and/or generate data as to a position and/or location in which the vehicle 100 is located and/or is travelling, and including conditions surrounding the position and/or location (e.g., as to speed limits, road conditions, weather conditions, and/or other values). In certain embodiments, the navigation system 136 comprises and/or or is coupled to a satellite-based network and/or system, such as a global positioning system (GPS) and/or other satellite-based system.

In various embodiments, the transceiver 138 receives information regarding the location in which the vehicle 100 is being operated and about speed limits, traffic conditions, weather conditions, and/or other conditions at the location (e.g., in concert with the navigation system 136 in certain embodiments).

In various embodiments, the controller 140 is coupled to the sensor array 120, speaker array 130, navigation system 136, and transceiver 138. Also in various embodiments, the controller 140 comprises a computer system, and includes a processor 142, a memory 144, an interface 146, a storage device 148, and a computer bus 150. In various embodiments, the controller (or computer system) 140 controls sounds for the vehicle 100, including for generating Shepard tone sounds both for individuals inside the vehicle 100 and for individuals outside the vehicle 100, including for serving as an indication for how the vehicle 100 is operating and for facilitating desired behavior or comfort for such individuals. In various embodiments, the controller 140 determines the appropriate Shepard tone sounds based on the data and information from the sensor array 120, the navigation system 136 (and, also in various embodiments, also from data obtained via the transceiver 138), and provides instructions for the desired Shepard tones to be provided via the speaker array 130 (including the inside speakers 132 and the outside speakers 134). In various embodiments, the controller 140 provides these and other functions in accordance with the steps of the processes and implementations depicted in FIGS. 2-16 and as described further below in connection therewith.

In various embodiments, the controller 140 (and, in certain embodiments, the control system 102 itself) is disposed within the body 104 of the vehicle 100. In one embodiment, the control system 102 is mounted on the chassis 116. In certain embodiments, the controller 140 and/or control system 102 and/or one or more components thereof may be disposed outside the body 104, for example on a remote server, in the cloud, or other device where image processing is performed remotely.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the processes and implementations depicted in FIGS. 2-16 and as described further below in connection therewith.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with one or more sources 156 of the sounds (e.g., sine waves, instruments such as violins, oboes, pianos, and/or other sources) to be generated and provided for the vehicle 100.

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120 and/or the navigation system 136. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of the processes and implementations of FIGS. 2-16 and as described further below in connection therewith. In another exemplary embodiment, the program product may be directly stored in and/or otherwise accessed by the memory 144 and/or a secondary storage device (e.g., disk 157), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

With reference to FIG. 2, a flowchart is provided of a process 200 for controlling for the vehicle 100, including for generating Shepard tone sounds for individuals inside the vehicle 100 and for individuals outside the vehicle 100, in accordance with exemplary embodiments. As noted above, in various embodiments, the Shepard tone sounds are generated at least in part for serving as an indication for how the vehicle 100 is operating and for facilitating desired behavior or comfort for such individuals.

As depicted in FIG. 2, the process 200 begins at step 202 when the vehicle 100 of FIG. 1 is started when the vehicle 100 begins operation. In various embodiments, the process 200 continues until the vehicle 100 operation terminates.

In various embodiments data is obtained (step 204). In various embodiments, sensor data is obtained from the various sensors of the sensor array 120 of FIG. 1, including the speed sensors 122, the input sensors 124, the detection sensors 126, and the other sensors 128 thereof. In various embodiments, the sensor data includes data as to inputs or selections from a user of the vehicle 100 (e.g., as to a selected mode of operation of the vehicle 100) as well as data as to the operation of the vehicle 100 (e.g., including vehicle speed, acceleration, motor torque, accelerator pedal and brake pedal engagement, and so on) and as to an environment surrounding the vehicle 100 (e.g., the roadway, detected objects, traffic conditions, and so on). Also in various embodiments, data is also obtained via the navigation system 136 and/or the transceiver 138, including for example as to the roadway on which the vehicle 100 is travelling, speed limits for the roadway, weather, traffic, and/or other conditions as to the roadway, and so on.

In various embodiments, a mode of operation for the vehicle is determined (step 206). In various embodiments, the mode of operation is determined by the processor 142 of FIG. 1 using the data of step 204. Also in various embodiments, the mode of operation comprises a mode of operation for the vehicle 100 of FIG. 1 as selected by a user of the vehicle 100, as determined based on the data of step 204. In various embodiments, the mode of operation may comprise, among other possible modes of operation, a standard mode of operation (e.g., a default mode), a sport mode of operation (e.g., in which the vehicle 100 is more responsive and sensitive to input, as compared with the standard mode of operation), a manual mode of operation (e.g., controlled by the human driver), a fully autonomous mode of operation (e.g., controlled by the processor 142), a semi-autonomous mode of operation (e.g., controlled in part by the human driver and in part by the processor 142), and so on.

Also in various embodiments, additional details as to the operation of the vehicle 100 and its surroundings are determined (step 208). In various embodiments, the additional details as to the operation of the vehicle 100 and its surroundings are determined by the processor 142 of FIG. 1 using the data of step 204. Also in various embodiments, the additional details of step 208 may include the following details, among others: a speed of the vehicle 100, an acceleration of the vehicle 100, a steering angle of the vehicle 100, a motor torque of the vehicle 100, a user's engagement of the accelerator pedal and/or brake of the vehicle 100, a speed limit of the roadway, traffic conditions of the roadway, weather conditions of the roadway, detection of emergency vehicles and/or other vehicles and/or objects along the roadway, the presence of a school zone, construction zone and/or other conditions of caution, and so on.

In various embodiments, a desired interior sound is determined (step 210). In various embodiments, during step 210, the processor 142 of FIG. 1 determines one or more desired Shepard tone sounds to provide via the inside speakers 132 of the vehicle 100 based on the available information, including the data of step 204 and the determinations of steps 206 and 208. In various embodiments, the interior sounds are to be provided using the one or more Shepard tones for one or more individuals that are disposed inside a cabin of the vehicle 100, and specifically to generate the perception of different directions and magnitudes of perceived pitch change rates as perceived by the individuals inside the vehicle 100. In various embodiments, this is performed, for example, in order to alert such individuals inside the vehicle 100 as to operation of the vehicle 100 and/or its surroundings, and/or to make the individuals inside the vehicle 100 more comfortable and/or to influence the behavior of the individuals inside the vehicle 100 (e.g., a driver of the vehicle 100). For example, in certain embodiments, the interior sounds may include a perceived increase in pitch change rate when attempting to influence the driver to take certain actions, such as braking and/or steering, and so on. By way of additional example, the interior sounds may in appropriate circumstances include a perceived decrease in pitch change rate when providing the driver or other individuals inside the vehicle 100 with an enhanced feeling of calmness and/or safety when the vehicle 100 is taking autonomous actions, and so on. (e.g., which may be more likely to be effective when the discrepancy between the two is less than a predetermined threshold). Various specific implementations of the desired interior sounds are presented further below in connection with Table 1, and will be described in greater detail further below in connection therewith, in accordance with exemplary embodiments.

Also in various embodiments, a desired exterior sound is determined (step 212). In various embodiments, during step 210, the processor 142 of FIG. 1 determines one or more desired Shepard tone sounds to provide via the outside speakers 134 of the vehicle 100 based on the available information, including the data of step 204 and the determinations of steps 206 and 208. In various embodiments, the exterior sounds are to be provided using the one or more Shepard tones for one or more individuals that are disposed outside the vehicle 100, and specifically to generate the perception of different directions and magnitudes of perceived pitch change rates as perceived by the individuals outside the vehicle 100. In various embodiments, this is performed, for example, in order to alert such individuals outside the vehicle 100 as to operation of the vehicle 100, and/or to make the individuals outside the vehicle 100 more comfortable and/or to influence the behavior of the individuals outside the vehicle 100. For example, in certain embodiments, the exterior sounds may include a perceived increase in pitch change rate when attempting to influence the individual to take certain actions, such as to avoid movement in front of the vehicle 100, and so on. Various specific implementations of the desired exterior sounds are presented further below in connection with Table 1, and will be described in greater detail further below in connection therewith, in accordance with exemplary embodiments.

In various embodiments, the desired interior sounds are provided (step 214) along with the desired exterior sounds (step 216). Specifically, in various embodiments, during step 214 the processor 142 provides instructions to the inside speakers 132 of FIG. 1 to provide the desired interior sound of step 210 that include one or more Shepard tones for the individuals inside the vehicle 100. Similarly, also in various embodiments, during step 216 the processor 142 provides instructions to the outside speakers 134 of FIG. 1 to provide the desired exterior sound of step 212 that include one or more Shepard tones for the individuals outside the vehicle 100. Also in various embodiments, one or more noise cancelling techniques may also be implemented so as to segregate the interior sounds from the exterior sounds.

In various embodiments, a determination is also made during step 218 as to whether the process 200 is to continue. In various embodiments, this determination is made by the processor 142 of FIG. 1, for example as to whether the vehicle 100 is continuing operation (e.g., in a current drive cycle).

In various embodiments, if it is determined during step 218 that the process 200 is to continue, then the process 200 returns to step 204, and steps 204-218 continue in a new iteration. Conversely, in various embodiments, once it is determined during an iteration of step 218 that the process is not to continue, then the process terminates at step 220.

As alluded to above, Table 1 below provides an illustration of the types of desired interior sounds (of steps 210 and 214) and exterior sounds (of steps 212 and 216) that may be implemented using different Shepard tones in various exemplary implementations of the process 200 of FIG. 1.

TABLE 1

| | Driver/Passenger Perceived | | | Pedestrian Perceived | | |
|---|---|---|---|---|---|---|
| | Pitch Change Rate | | | Pitch Change Rate | | |
| | Accel | Steady | Decel | Accel | Steady | Decel |
| Standard driving mode | Medium | No | Medium | Medium | No | Medium |
| | increase | change | decrease | increase | change | decrease |
| Sport driving mode | High | No | High | Medium | No | Medium |
| | increase | change | decrease | increase | change | decrease |
| Autonomous driving | Low | No | Low | Low | No | High |
| mode | increase | change | decrease | increase | change | decrease |
| Vehicle approaches | High | Low | Medium | Medium | No | Medium |
| construction/ambulance | increase | increase | decrease | increase | change | decrease |
| Autonomous | High | Low | Medium | Medium | No | Medium |
| disengagement | increase | increase | decrease | increase | change | decrease |

As illustrated in Table 1 above, in various embodiments, when the driver selects a standard (e.g., default) driving mode, the interior sounds (e.g., the perceived pitch rate change as perceived by the individuals inside the vehicle 100) include the following: (i) a medium increase when the vehicle 100 is accelerating; (ii) no change when the vehicle 100 is in a steady state without acceleration or deceleration; and (iii) a medium decrease when the vehicle 100 is decelerating. Also in this standard mode, in various embodiments the exterior sounds (e.g., the perceived pitch rate change as perceived by the individuals outside the vehicle 100) include the following: (i) a medium increase when the vehicle 100 is accelerating; (ii) no change when the vehicle 100 is in a steady state without acceleration or deceleration; and (iii) a medium decrease when the vehicle 100 decelerating.

As used throughout, in various embodiments, the term “low increase” or “low decrease” refers to an increase or decrease, respectively in the perceived pitch rate change that is greater in the magnitude of its absolute value (e.g., in the respective direction) than “no change” but that is smaller in the magnitude of its absolute value less than a “medium increase” or “medium decrease” (respectively). Likewise, as used throughout, in various embodiments, the term “medium increase” or “medium decrease” refers to an increase or decrease, respectively in the perceived pitch rate change that is greater in the magnitude of its absolute value (e.g., in the respective direction) than “low increase” or “low decrease” (respectively) but that is smaller in the magnitude of its absolute value less than a “high increase” or “high decrease” (respectively).

As further illustrated in Table 1 above, in various embodiments, when the driver selects a sport driving mode, the interior sounds (e.g., the perceived pitch rate change as perceived by the individuals inside the vehicle 100) include the following: (i) a high increase when the vehicle 100 is accelerating (e.g., such that the perceived acceleration from the pitch rate change would be greater than the actual acceleration of the vehicle); (ii) no change when the vehicle 100 is in a steady state without acceleration or deceleration; and (iii) a high decrease when the vehicle 100 is decelerating (e.g., such that the perceived deceleration from the pitch rate change would be greater than the actual deceleration of the vehicle). Also in this sport driving mode, in various embodiments the exterior sounds (e.g., the perceived pitch rate change as perceived by the individuals outside the vehicle 100) include the following: (i) a medium increase when the vehicle 100 is accelerating; (ii) no change when the vehicle 100 is in a steady state without acceleration or deceleration; and (iii) a medium decrease when the vehicle 100 decelerating.

Also as illustrated in Table 1 above, in various embodiments, when the driver selects an autonomous driving mode, the interior sounds (e.g., the perceived pitch rate change as perceived by the individuals inside the vehicle 100) include the following: (i) a low increase when the vehicle 100 is accelerating (e.g., such that the perceived acceleration from the pitch rate change would be less than the actual acceleration of the vehicle); (ii) no change when the vehicle 100 is in a steady state without acceleration or deceleration; and (iii) a low decrease when the vehicle 100 is decelerating (e.g., such that the perceived deceleration from the pitch rate change would be less than the actual deceleration of the vehicle). Also in this autonomous mode, in various embodiments the exterior sounds (e.g., the perceived pitch rate change as perceived by the individuals outside the vehicle 100) include the following: (i) a low increase when the vehicle 100 is accelerating; (ii) no change when the vehicle 100 is in a steady state without acceleration or deceleration; and (iii) a high decrease when the vehicle 100 decelerating.

In addition, as illustrated in Table 1 above, in various embodiments, when the vehicle 100 is approaching a potential hazard or other condition (e.g., as the vehicle 100 approaches a construction zone, or is near an ambulance and/or other emergency vehicle), the interior sounds (e.g., the perceived pitch rate change as perceived by the individuals inside the vehicle 100) include the following: (i) a high increase when the vehicle 100 is accelerating; (ii) a low increase when the vehicle 100 is in a steady state without acceleration or deceleration; and (iii) a medium decrease when the vehicle 100 is decelerating. Also under these conditions, in various embodiments the exterior sounds (e.g., the perceived pitch rate change as perceived by the individuals outside the vehicle 100) include the following: (i) a medium increase when the vehicle 100 is accelerating; (ii) no change when the vehicle 100 is in a steady state without acceleration or deceleration; and (iii) a medium decrease when the vehicle 100 decelerating.

In addition, as illustrated in Table 1 above, in various embodiments, when a transition or hand off between autonomous driving and manual driving is occurring or about to occur, the following variations may be implemented (e.g., to help make the transition or hand off from automation to human driving more efficient): the interior sounds (e.g., the perceived pitch rate change as perceived by the individuals inside the vehicle 100) include the following: (i) a high increase when the vehicle 100 is accelerating; (ii) a low increase when the vehicle 100 is in a steady state without acceleration or deceleration; and (iii) a medium decrease when the vehicle 100 is decelerating. Also under these conditions, in various embodiments the exterior sounds (e.g., the perceived pitch rate change as perceived by the individuals outside the vehicle 100) include the following: (i) a medium increase when the vehicle 100 is accelerating; (ii) no change when the vehicle 100 is in a steady state without acceleration or deceleration; and (iii) a medium decrease when the vehicle 100 decelerating (e.g., in various embodiments, it is assumed that this will create a greater awareness to the vehicle by pedestrians and road users). In various embodiments, when a transition is occurring (e.g., between autonomous and manual driving modes), the greater perceived rate of vehicle acceleration or deceleration (from the Shepard tone pitch for the sound) is intended to help alert the driver of the changes in operating mode that are occurring (and, for example, that can be further emphasized with greater changes in the tone pitch when the driver is not responding appropriately via engagement of the accelerator pedal, brake pedal, steering wheel, and so on).

In various embodiments, the sounds provided for the vehicle 100 (including the Shepard tones for both the exterior sounds and the interior sounds) are generated using one or more sources 156 of sounds of FIG. 1, for example that are stored in the memory 144 of FIG. 1. In certain embodiments, one or more different musical instruments and/or other sources 156 may be utilized for the sounds. For example, in one embodiment: a sine wave may be used as the basis for the sound in a standard driving made; a violin may be used as the basis for the sound for a sport mode, and an oboe may be used as the basis for the sound in an autonomous driving mode, and so on, among various other potential sources 156 and/or combinations in various embodiments.

In addition, in certain embodiments, the sounds provided for the vehicle 100 (including the Shepard tones for both the exterior sounds and the interior sounds) may be constructed in octaves. However, this may vary in other embodiments, for example in that half octaves and quarter octaves may also be used, among other possibilities.

With reference to FIGS. 3-16, various exemplary implementations are provided for the process 200 of FIG. 1. In various embodiments, these implementations may also be utilized in accordance with the vehicle 100, including the control system 102 and components thereof, of FIG. 1.

First, with reference to FIG. 3, an exemplary illustration 300 is provided in which the rate of sound pitch increase is proportional to the acceleration rate for the vehicle 100, and there is a fixed relationship between sound and speed. Specifically, as shown in FIG. 3, in an exemplary embodiment, an x-axis 301 represents time, while a y-axis 304 represents a tone frequency (or pitch) (e.g., as to the sound's fundamental frequency). Also as shown in FIG. 3, in an exemplary embodiment, the perceived sound acceleration 312 is proportional to the actual acceleration rate 310, for example as the vehicle speed 303 increases to a particular value 308 (e.g., 100 miles per hour in an exemplary embodiment) while the tone frequency (or pitch) increases from a minimum value (f-min) 304 to a maximum value (f-max) 306.

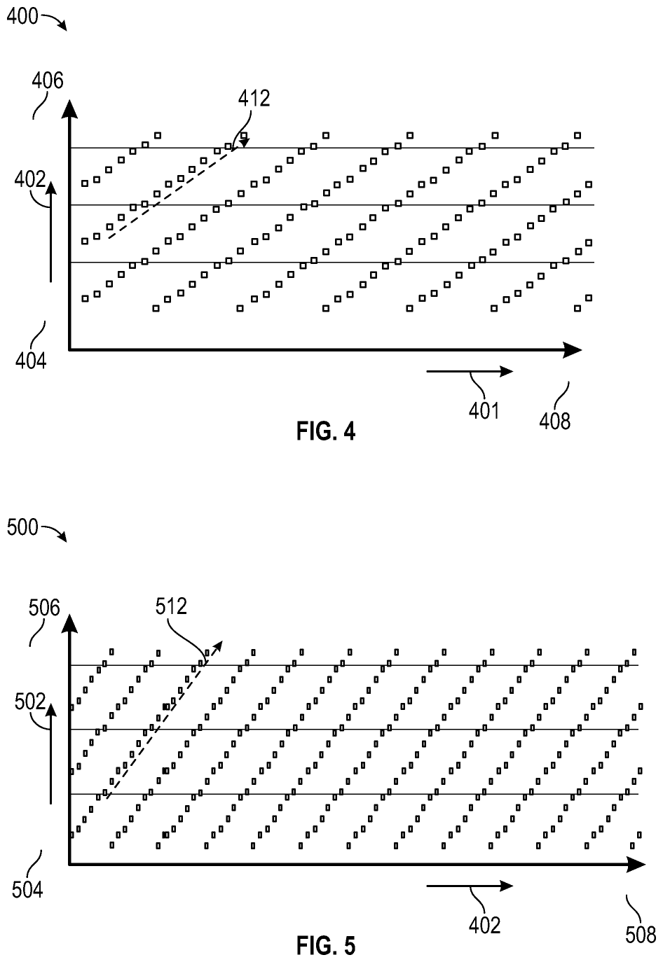

Next, with reference to FIG. 4, an exemplary illustration 400 is provided in which a Shepard tone approach is implemented in accordance with the process 200 of FIG. 2, in a first driving mode corresponding to a standard (or default) driving mode. Specifically, as shown in FIG. 4, in an exemplary embodiment, an x-axis 401 represents vehicle speed, increasing to a particular value 408 (e.g., 100 miles per hour in an exemplary embodiment), while ay-axis 402 represents a tone frequency (or pitch). Also as shown in FIG. 4, in an exemplary embodiment, the perceived sound acceleration 412 increases with vehicle speed. In addition, in this exemplary embodiment, the use of the Shepard tone allows the process 200 to provide vehicle sound that appears represent acceleration or deceleration of the vehicle without altering the minimum pitch (f-min) 404 and maximum pitch (f-max) 406 (which may be selected by the control system 102 of FIG. 1 to represent a range of pleasant sounds for the user).

Next, with reference to FIG. 5, an exemplary illustration 500 is provided in which a similar Shepard tone approach is implemented in accordance with the process 200 of FIG. 2, in a second driving mode corresponding to a sport driving mode. Specifically, as shown in FIG. 5, in an exemplary embodiment, and similar to FIG. 4, an x-axis 501 represents vehicle speed, increasing to a particular value 508 (e.g., 100 miles per hour in an exemplary embodiment), while a y-axis 502 represents atone frequency (or pitch). Also as shown in FIG. 5, in an exemplary embodiment, the perceived sound acceleration 512 increases with vehicle speed, while remaining within the minimum pitch (f-min) 504 and maximum pitch (f-max) 506. However, in contrast to FIG. 4, in an exemplary embodiment the implementation of FIG. 5 provides a greater (or steeper) slope with respect to the tone frequency changes, such that the sound will appear to be accelerating faster in the sport mode of FIG. 5 (as compared with the standard mode of FIG. 4).

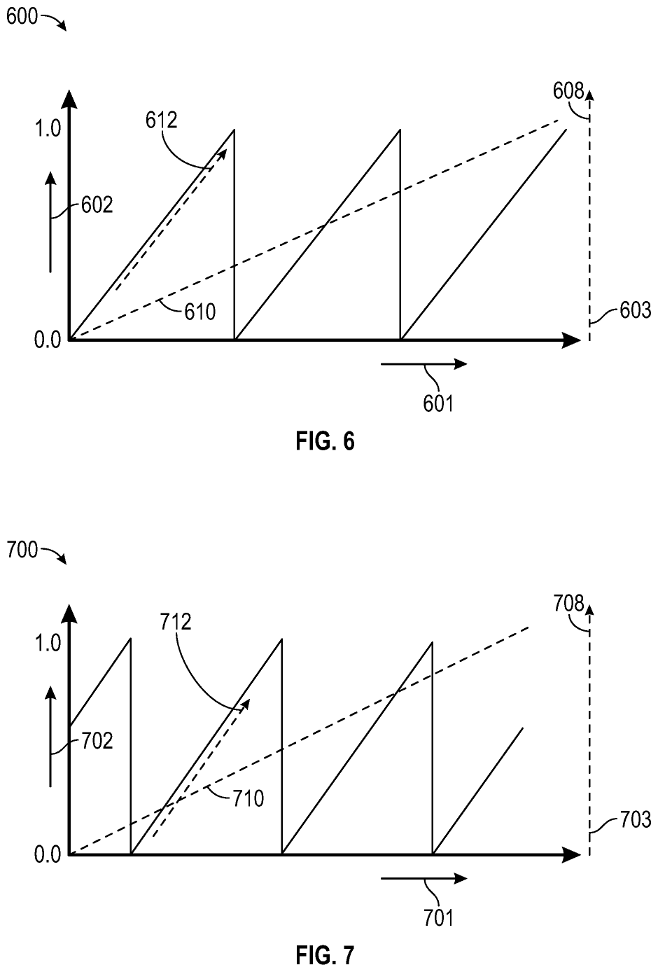

Next, with reference to FIG. 6, an exemplary illustration 600 is provided in which a Shepard tone approach is implemented in accordance with the process 200 of FIG. 2. Specifically, as shown in FIG. 6, in an exemplary embodiment, an x-axis 601 represents time, while a y-axis 602 represents a Shepard tone index (e.g., on scale between 0.0 and 1.0).

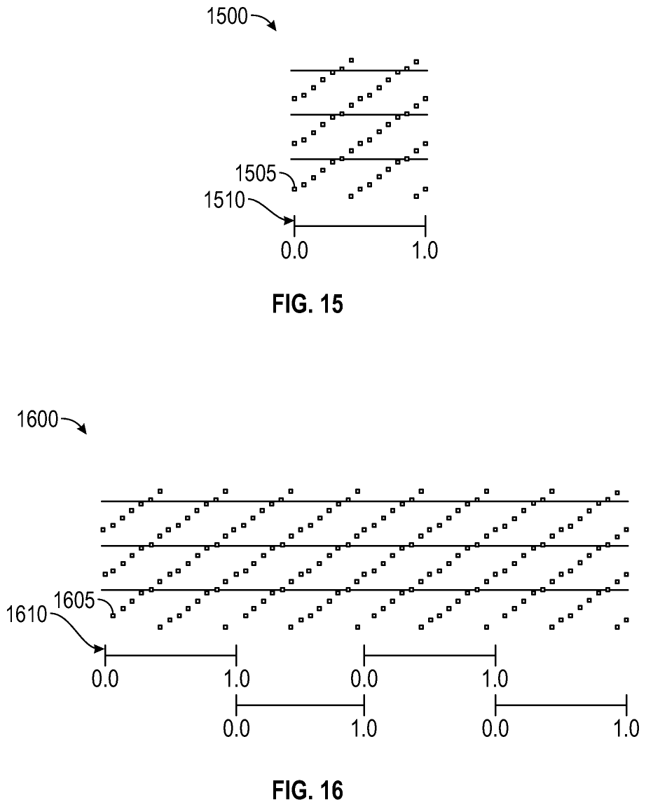

As used throughout the Application, the “Shepard Tone Index” refers to a number between 0.0 and 1.0, each value represents a unique portion of the Shepard Tone. For example, with respect to FIGS. 15 and 16, exemplary illustrations are provided to illustrate the use of the Shepard Tone Index in an exemplary embodiment.

First, FIG. 15 provides a first illustration 1500 in which various sound notes 1505 collectively comprise a Shepard Tone Index 1510 that is performed a single time in FIG. 15, in accordance with an exemplary embodiment. As shown in FIG. 15, in various embodiments the Shepard Tone Index 1510 ranges from assigned values of 0.0 (representing the first sound note in the Shepard Tone Index) to 1.0 (representing the last sound in the Shepard Tone Index).

Next, FIG. 16 provides a second illustration 1600 in which various sound notes 1605 collectively comprise a Shepard Tone Index 1610 that is repeated in FIG. 16 in an exemplary embodiment. As shown in FIG. 16, and similar to FIG. 15, in various embodiments the Shepard Tone Index 1610 ranges from assigned values of 0.0 (representing the first sound note in the Shepard Tone Index) to 1.0 (representing the last sound in the Shepard Tone Index). However, the embodiment of FIG. 16 further provides that the Shepard Tone Index 1610 is repeated any number of times as necessary. For example, in an exemplary embodiment, whenever the process 200 calls for a given Shepard Tone Index 1610 to be played, the process 200 is calling for those notes corresponding to that Shepard Tone Index 1610 to be played and repeated as necessary. For example, in one exemplary embodiment, if the vehicle 100 were traveling at a steady speed (e.g., sixty miles per hour, in one exemplary embodiment), the process 200 may provide at that moment to play a particular Shepard Tone Index 1610 (e.g., Shepard Tone Index 0.57, in one exemplary embodiment), which would be repeated as long as the vehicle 100 remained at this steady speed, and so on.

With reference back to FIG. 6, in an exemplary embodiment, the Shepard Tone Index (e.g., on scale between 0.0 and 1.0) is represented by the y-axis 602, with time being represented by the x-axis 601 (as noted above). In addition, as shown in FIG. 6, in an exemplary embodiment, the vehicle speed 610 increases, for example from a minimum value 603 (e.g., zero) to a potential maximum value 608 (e.g., 100 miles per hour). Also as shown in FIG. 6, in an exemplary embodiment, the perceived sound acceleration rate 612 increases, and for example can be made to increase faster (e.g., with a greater slope) than the vehicle speed 610. In certain embodiments, the implementation of FIG. 6 corresponds to a standard (or default) mode of operation for the vehicle 100 (e.g., as opposed to the sport mode described herein).

Next, with reference to FIG. 7, an exemplary illustration 700 is provided in which another Shepard tone approach is implemented in accordance with the process 200 of FIG. 2. Specifically, as shown in FIG. 7, and similar to FIG. 6, in an exemplary embodiment, an x-axis 701 represents time, while a y-axis 702 represents the Shepard tone index (e.g., on scale between 0.0 and 1.0). Also as shown in FIG. 7, in an exemplary embodiment, the vehicle speed 710 similarly increases, for example from a minimum value 703 (e.g., zero) to a potential maximum value 708 (e.g., 100 miles per hour). Also as shown in FIG. 7, and similar to FIG. 6, in an exemplary embodiment, the perceived sound acceleration rate 712 increases, and for example can be made to increase faster (e.g., with a greater slope) than the vehicle speed 710. In certain embodiments, the implementation of FIG. 7 also corresponds to a standard (or default) mode of operation for the vehicle 100 (e.g., as opposed to the sport mode described herein). However, in contrast to FIG. 6, the implementation of FIG. 7 illustrates that the Shepard tone may be introduced with starting points, and that a speed of zero miles per hour does not necessarily need to correspond with a 0.0 Shepard tone index in accordance with various embodiments of the process 200 of FIG. 2.

For example, in certain embodiments, the sound may replicate vehicle acceleration by playing the Shepard tone sound loop from 0.0 to 1.0 over a period of two seconds. In various other embodiments, the sound can make it appear as though the vehicle 100 is accelerating more rapidly, such as change from 0.0 to 1.0 over a period of one second, and the repeating again, and so on.

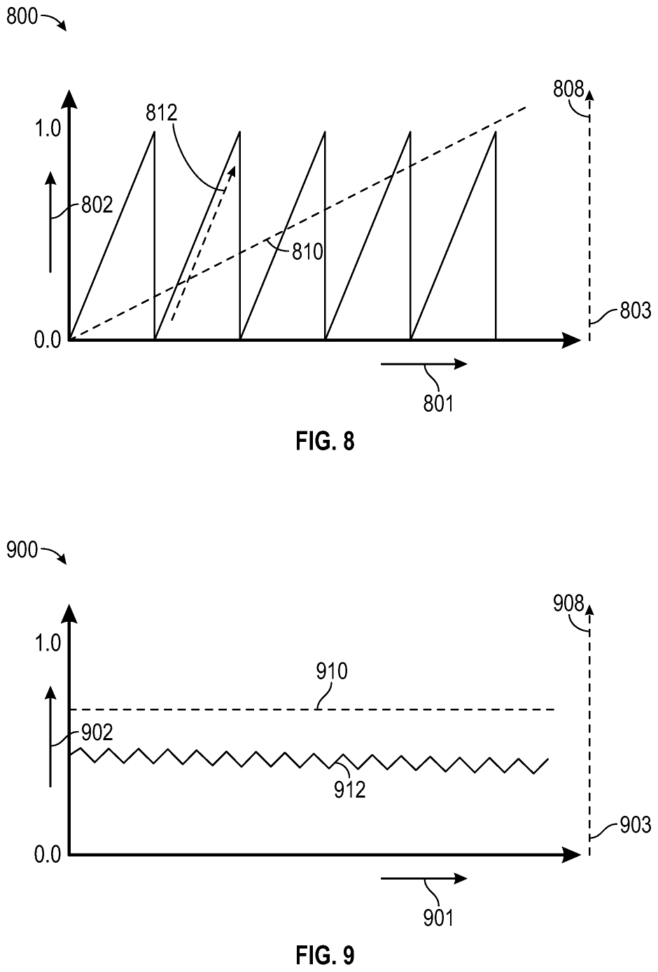

Next, with reference to FIG. 8, an exemplary illustration 800 is provided in which another Shepard tone approach is implemented in accordance with the process 200 of FIG. 2, in which the vehicle 100 is operating in a sport mode (in contrast to the standard mode of FIGS. 6 and 7). Specifically, as shown in FIG. 8, an x-axis 801 represents time, while a y-axis 802 represents the Shepard tone index (e.g., on scale between 0.0 and 1.0). Also as shown in FIG. 8, in an exemplary embodiment, the vehicle speed 810 similarly increases, for example from a minimum value 803 (e.g., zero) to a potential maximum value 808 (e.g., 100 miles per hour). Also as shown in FIG. 8, the perceived sound acceleration rate 812 increases at a rate that is not only faster (e.g., with a greater slope) than the vehicle speed 810, but also that is faster (e.g., with a greater slope) with the sport mode of FIG. 8 as compared with the standard mode of FIGS. 6 and 7.

Next, with reference to FIG. 9, an exemplary illustration 900 is provided in which another Shepard tone approach is implemented in accordance with the process 200 of FIG. 2, in which the vehicle 100 is operating in a steady state condition (e.g., in which vehicle speed is constant, or approximately constant, with little or no variation). Specifically, as shown in FIG. 9, an x-axis 901 represents time, while a y-axis 902 represents the Shepard tone index (e.g., on scale between 0.0 and 1.0). Also as shown in FIG. 9, in an exemplary embodiment, as the vehicle speed 910 has a minimum value 903 (e.g. zero) and a maximum value 908 (e.g., 100 miles per hour). As shown in FIG. 9, as the vehicle speed 910 remains constant in the steady state operation, in an exemplary embodiment the tone frequency 912 remains approximately constant. In certain embodiments, a constant pitch, such as approximately 0.55 on a scale from 0.0 to 1.0, is provided. In addition, as shown in FIG. 9, in an exemplary embodiment, the tone frequency 912 may vary slightly up and down (e.g., in a saw tooth or sinusoid pattern as illustrated in FIG. 9) in order to improve comfort for the user (e.g., similar to how professional singers may implement “vibrato” in their tone for to improve the listening tone for the audience, and so on).

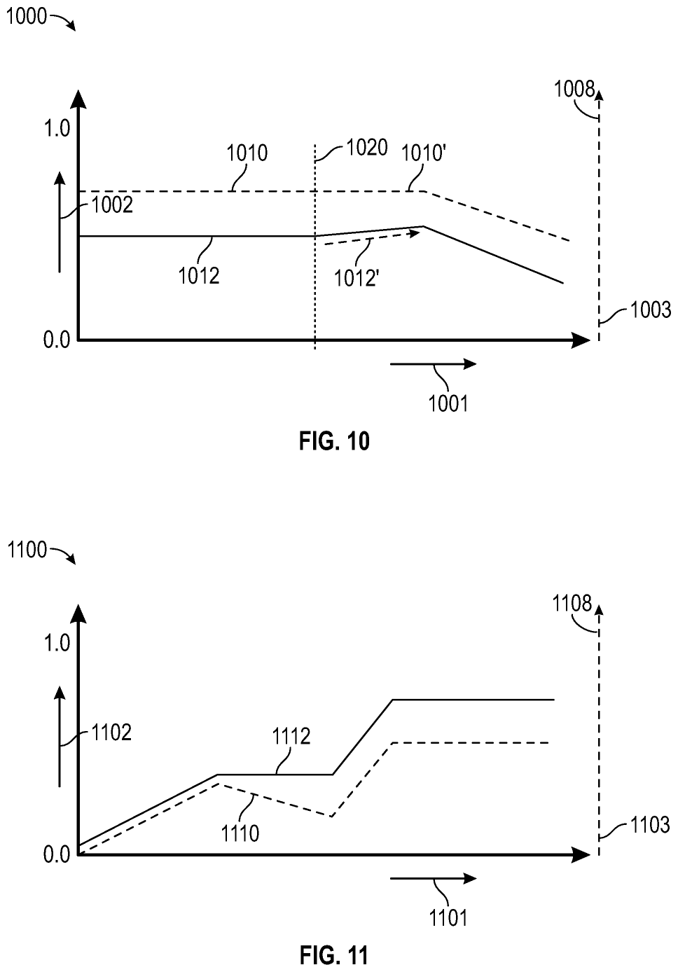

Next, with reference to FIG. 10, an exemplary illustration 1000 is provided in which another Shepard tone approach is implemented in accordance with the process 200 of FIG. 2, representing the interior sound in which the vehicle 100 is encountering a situation that may require particular caution (e.g., in which the vehicle 100 is approaching a school zone or construction zone, or in which an ambulance is approaching, or the like). Specifically, as shown in FIG. 10, an x-axis 1001 represents time, while a y-axis 1002 represents the Shepard tone index (e.g., on scale between 0.0 and 1.0). Also as shown in FIG. 10, in an exemplary embodiment, as the vehicle speed 1010 has a minimum value 1003 (e.g. zero) and a maximum value 1008 (e.g., 100 miles per hour). As shown in FIG. 10, as the vehicle 100 encounters the situation of caution at point 1020 (e.g., as the vehicle 100 enters the construction zone or the school zone, or the ambulance approaches the vehicle 100, or the like), the vehicle speed 1010 is expected to decrease (represented by 1010′). In various embodiments, during this time, the tone frequency 1012 may initially increase (represented by 1012′). In various embodiments, this is performed in order to provide the illusion that the speed of the vehicle 100 is increasing, to thereby encourage the driver of the vehicle 100 to decrease the speed of the vehicle 100 and to exercise additional caution in operating the vehicle 100. In certain embodiments, once the speed 1010 of the vehicle has decreased to an appropriate level (represented by 1010′ in FIG. 10), the tone frequency 1012′ may likewise decreases as shown in FIG. 10. Also in certain embodiments, the Shepard tone may begin at a first level (e.g., 0.55 on a scale of 0.0 to 1.0) and then transition (e.g., over a period of ten seconds) to a second level (e.g., 0.60 on a scale of 0.0 to 1.0).

Next, with reference to FIG. 11, an exemplary illustration 1100 is provided in which another Shepard tone approach is implemented in accordance with the process 200 of FIG. 2, in which a propulsion-only sound is provided for the vehicle 100 using the Shepard tone. Specifically, as shown in FIG. 11, an x-axis 1101 represents time, while a y-axis 1102 represents the Shepard tone index (e.g., on scale between 0.0 and 1.0). Also as shown in FIG. 11, in an exemplary embodiment, as the vehicle speed 1110 has a minimum value 1103 (e.g. zero) and a maximum value 1108 (e.g., 100 miles per hour). As shown in FIG. 11, in an exemplary embodiment, as the vehicle 100 is accelerating (i.e., as the speed 1110 is increasing), the vehicle 100 appears to be accelerating via the sound (i.e., as the tone frequency 1112 increases along with the speed 1110 of the vehicle 100). However, also in this embodiment, as the vehicle 100 is decelerating (i.e., as the speed 1110 is decreasing), the tone frequency 1112 remains relatively constant rather than decreasing along with the speed 1110 (e.g., for potentially improved comfort for the user).

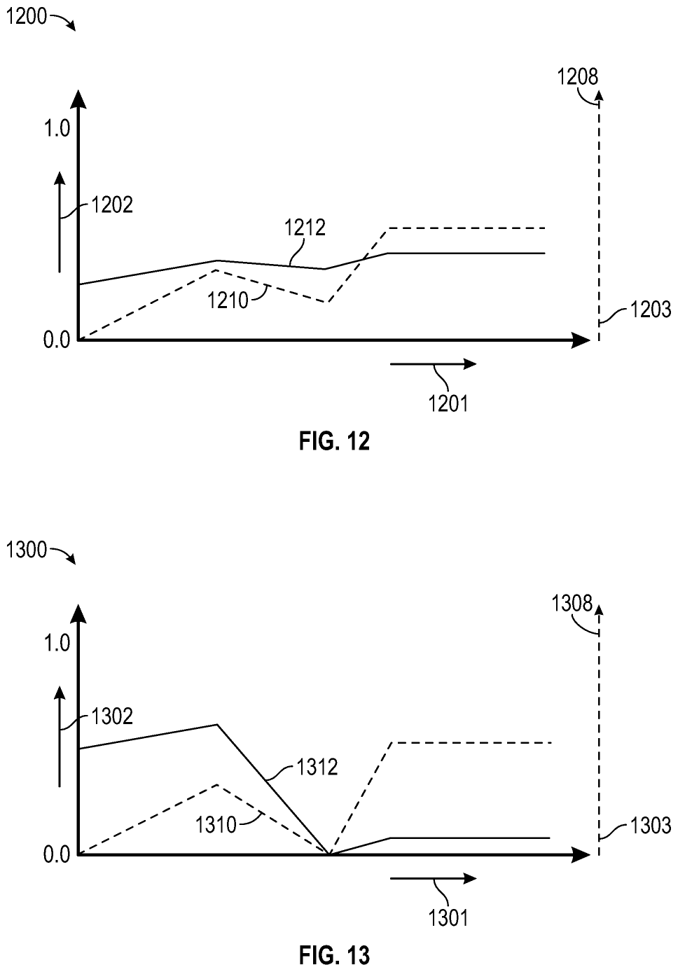

Next, with reference to FIG. 12, an exemplary illustration 1200 is provided in which another Shepard tone approach is implemented in accordance with the process 200 of FIG. 2, in which an interior sound is provided that reduces the perception of speed changes during autonomous operation of the vehicle 100. Specifically, as shown in FIG. 12, an x-axis 1201 represents time, while a y-axis 1202 represents the Shepard tone index (e.g., on scale between 0.0 and 1.0). Also as shown in FIG. 12, in an exemplary embodiment, as the vehicle speed 1210 has a minimum value 1203 (e.g. zero) and a maximum value 1208 (e.g., 100 miles per hour). As shown in FIG. 12, in an exemplary embodiment, as the vehicle 100 is accelerating (i.e., as the speed 1210 is increasing), the vehicle 100 appears to be accelerating, but at a slower or more gradual rate as compared with the actual acceleration of the vehicle 100 (i.e., as the tone frequency 1212 increases along with the speed 1210 of the vehicle 100, but at a lesser or more gradual extent as compared with the speed 1210 of the vehicle 100). Likewise, also as shown in FIG. 12, in an exemplary embodiment, as the vehicle 100 is decelerating (i.e., as the speed 1210 is decreasing), the vehicle 100 appears to be decelerating, but at a slower or more gradual rate as compared with the actual deceleration of the vehicle 100 (i.e., as the tone frequency 1212 decreases along with the speed 1210 of the vehicle 100, but at a lesser or more gradual extent as compared with the speed 1210 of the vehicle 100). In various embodiments, this relatively gradual approach is implemented in order to potentially improve comfort for the passengers inside the vehicle 100.

Next, with reference to FIG. 13, an exemplary illustration 1300 is provided in which another Shepard tone approach is implemented in accordance with the process 200 of FIG. 2, in which an exterior sound is provided in a manner that potentially helps improve the perception of safety and comfort by individuals outside the vehicle 100 (e.g., pedestrians). Specifically, as shown in FIG. 13, an x-axis 1301 represents time, while ay-axis 1302 represents the Shepard tone index (e.g., on scale between 0.0 and 1.0). Also as shown in FIG. 13, in an exemplary embodiment, as the vehicle speed 1310 has a minimum value 1303 (e.g. zero) and a maximum value 1308 (e.g., 100 miles per hour). As shown in FIG. 13, in an exemplary embodiment, similar to FIG. 12, the tone frequency 1312 increases as the vehicle 100 accelerates (i.e., as the vehicle speed 1310 increases) and decreases as the vehicle decelerates (i.e., as the vehicle speed 1310 decreases). However, in contrast to FIG. 12, in the exemplary embodiment of FIG. 13, as the vehicle 100 decelerates, the tone frequency 1312 decreases at a rate that is faster (i.e., with a larger magnitude of the downward slope) than the rate of decrease in the vehicle speed 1310 (e.g., in order to provide the pedestrian with the assurance that the vehicle 100 is stopping). In various embodiments, this is performed such that the pedestrians will experience a perception of higher deceleration rate of the vehicle 100, so as to potentially improve the pedestrian's sense of safety and comfort with respect to the approaching vehicle 100. Also in the exemplary embodiment of FIG. 13, as the vehicle 100 accelerates, the tone frequency 1312 increases at a rate that is slower (i.e., with a smaller magnitude of the upward slope) than the rate of increase in the vehicle speed 1310 (e.g., in order to provide the pedestrian with a sense of comfort and calm that the vehicle 100 is gently accelerating away from the pedestrian).

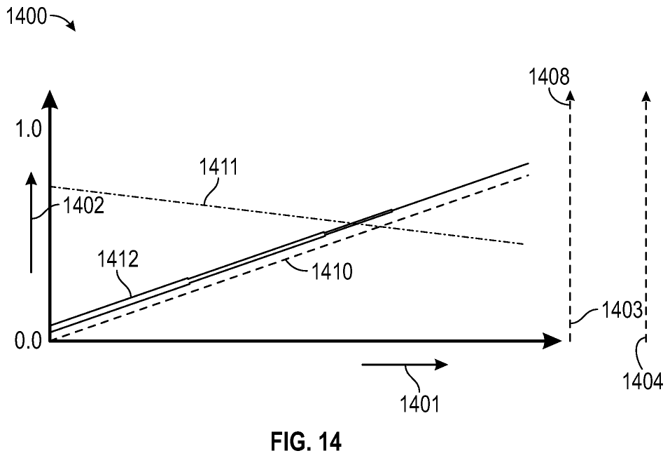

Next, with reference to FIG. 14, an exemplary illustration 1400 is provided in which another Shepard tone approach is implemented in accordance with the process 200 of FIG. 2, in accordance with another exemplary embodiment in which the vehicle sound is influenced by both the vehicle acceleration as well as propulsion motor torque. Specifically, as shown in FIG. 14, an x-axis 1401 represents time, while a y-axis 1402 represents the Shepard tone index (e.g., on scale between 0.0 and 1.0). Also as shown in FIG. 14, in an exemplary embodiment, the vehicle speed 1410 has a minimum value 1403 (e.g. zero) and a maximum value 1408 (e.g., 100 miles per hour), and is shown increasing over time in FIG. 14. Also as shown in FIG. 14, in an exemplary embodiment, the propulsion motor torque 1411 is shown decreasing over time. In addition, in the exemplary embodiment of FIG. 14, the tone frequency 1412 is illustrated as decreasing, corresponding to an increase in the vehicle speed 1410 and a decrease in the propulsion motor torque 1411. In certain exemplary embodiments, in accordance with the exemplary implementation of FIG. 14, the Shepard tone may also change in volume (loudness) as well as perceived pitch change. For example, as illustrated in FIG. 14, in an exemplary embodiment the increasing thickness of the tone frequency 1412 represents increasing volume of the Shepard tone. For example, in an exemplary embodiment, the volume of the tone could be proportional to the accelerator pedal position or propulsion motor torque while the pitch acceleration is proportional to actual vehicle acceleration. In certain embodiments, in this manner, the sound mimics the manner in which internal combustion engines rise in pitch and volume depending on speed and power.

Accordingly, methods, systems, and vehicles utilize Shepard tones to provide interior and exterior sounds for a vehicle based on various sensor data and other data pertaining to the operation of the vehicle as well as the vehicle's surroundings. As illustrated in the Figures as well as in the description above, in various embodiments, the Shepard tones are utilized for the interior and exterior sounds, for example, to influence behavior of a driver of the vehicle and/or to provide a potentially improved experience (e.g., an improved sense of comfort and/or safety) for occupants inside the vehicle as well as pedestrians and/or other individuals outside the vehicle.

In various embodiments, the techniques described herein may be used in connection with vehicles having a human driver, but that also have automatic functionality (e.g., automated parking and/or assisted driving). In various embodiments, the techniques described herein may also be used in connection autonomous vehicles, such as semi-autonomous and/or fully autonomous vehicles.

It will be appreciated that the systems, vehicles, and methods may vary from those depicted in the Figures and described herein. For example, the vehicle 100 of FIG. 1, the control system 102, and/or components thereof may differ from that depicted in FIG. 1. It will similarly be appreciated that the steps of the processes and implementations of FIGS. 2-16 may differ from those depicted in the Figures, and/or that various steps may occur concurrently and/or in a different order than that depicted in the Figures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining sensor data for a vehicle from one or more sensors of the vehicle;
determining, via a processor of the vehicle, a selected Shepard tone for a sound to be provided for the vehicle based on the sensor data; and
providing the sound for the vehicle, using the selected Shepard tone, via one or more speakers of the vehicle in accordance with instructions provided by the processor.

2. The method of claim 1, wherein:
the step of obtaining the sensor data comprises obtaining the sensor data as to an acceleration of the vehicle, from the one or more sensors of the vehicle;
wherein the step of determining the selected Shepard tone comprises determining, via the processor, the selected Shepard tone for the sound to be provided for the vehicle based on the acceleration of the vehicle.

3. The method of claim 2, wherein the selected Shepard tone is determined via the processor such that a perception of acceleration for the vehicle is provided that is greater than or less than an actual acceleration of the vehicle when the vehicle is accelerating.

4. The method of claim 2, wherein the selected Shepard tone is determined via the processor that a perception of deceleration for the vehicle is provided that is less than or greater than an actual deceleration of the vehicle when the vehicle is decelerating.

5. The method of claim 1, wherein:
the step of determining the selected Shepard tone comprises:
determining, via the processor, a first selected Shepard tone that influences a behavior of a driver inside the vehicle, provides comfort for one or more passengers inside the vehicle, or both; and
determining, via the processor, a second selected Shepard tone provides comfort for one or more pedestrians outside the vehicle; and
the step of providing the sound comprises:
providing an interior sound for the vehicle using the first selected Shepard tone, via one or more interior speakers of the vehicle in accordance with first instructions provided by the processor; and
providing an exterior sound for the vehicle using the second selected Shepard tone, via one or more exterior speakers of the vehicle in accordance with second instructions provided by the processor.

6. The method of claim 1, further comprising:
determining, via the processor, a mode of operation for the vehicle using the sensor data, wherein the mode of operation comprises either a standard mode of operation or a sport mode of operation for the vehicle;
wherein the step of determining the selected Shepard tone comprises determining, via the processor, the selected Shepard tone for the sound to be provided for the vehicle based on the mode of operation of the vehicle, and wherein a different selected Shepard tone is selected based on whether the mode of operation comprises the sport mode of operation versus the standard mode of operation.

7. The method of claim 1, further comprising:
determining, via the processor, a mode of operation for the vehicle using the sensor data, wherein the mode of operation comprises either an autonomous mode of operation or a manual mode of operation for the vehicle;
wherein the step of determining the selected Shepard tone comprises determining, via the processor, the selected Shepard tone for the sound to be provided for the vehicle based on the mode of operation of the vehicle, and wherein a different selected Shepard tone is selected based on whether the mode of operation comprises the autonomous mode of operation versus the manual mode of operation.

8. The method of claim 1, wherein:
the step of obtaining the sensor data comprises obtaining the sensor data as to a motor torque for the vehicle;
wherein the step of determining the selected Shepard tone comprises determining, via the processor, the selected Shepard tone for the sound to be provided for the vehicle based on the motor torque.

9. The method of claim 1, wherein:
the step of obtaining the sensor data comprises obtaining the sensor data as to one or more conditions of caution surrounding the vehicle, including a construction zone, a school zone, or an approaching ambulance;
wherein the step of determining the selected Shepard tone comprises determining, via the processor, the selected Shepard tone for the sound to be provided for the vehicle based on the one or more conditions of caution surrounding the vehicle.

10. A system comprising:
one or more sensors configured to obtain sensor data for a vehicle; and
a processor that is coupled to the one or more sensors and that is configured to at least facilitate:
determining a selected Shepard tone for a sound to be provided for the vehicle based on the sensor data; and
providing the sound for the vehicle, using the selected Shepard tone, via one or more speakers of the vehicle in accordance with instructions provided by the processor.

11. The system of claim 10, wherein:
the one or more sensors are configured to obtain the sensor data as to an acceleration of the vehicle; and
the processor is further configured to at least facilitate determining the selected Shepard tone for the sound to be provided for the vehicle based on the acceleration of the vehicle.

12. The system of claim 11, wherein the processor is configured to at least facilitate determining the selected Shepard tone such that a perception of acceleration for the vehicle is provided that is greater than or less than an actual acceleration of the vehicle when the vehicle is accelerating.

13. The system of claim 11, wherein the processor is configured to at least facilitate determining the selected Shepard tone such that a perception of deceleration for the vehicle is provided that is less than or greater than an actual deceleration of the vehicle when the vehicle is decelerating.

14. The system of claim 10, wherein the processor is further configured to at least facilitate:
determining a first selected Shepard tone that influences a behavior of a driver inside the vehicle, provides comfort for one or more passengers inside the vehicle, or both;
determining a second selected Shepard tone provides comfort for one or more pedestrians outside the vehicle;
providing an interior sound for the vehicle using the first selected Shepard tone, via one or more interior speakers of the vehicle in accordance with first instructions provided by the processor; and
providing an exterior sound for the vehicle using the second selected Shepard tone, via one or more exterior speakers of the vehicle in accordance with second instructions provided by the processor.

15. The system of claim 10, wherein the processor is further configured to at least facilitate:
determining a mode of operation for the vehicle using the sensor data, wherein the mode of operation comprises either a standard mode of operation or a sport mode of operation for the vehicle; and
determining the selected Shepard tone for the sound to be provided for the vehicle based on the mode of operation of the vehicle, and wherein a different selected Shepard tone is selected based on whether the mode of operation comprises the sport mode of operation versus the standard mode of operation.

16. The system of claim 10, wherein the processor is further configured to at least facilitate:
determining a mode of operation for the vehicle using the sensor data, wherein the mode of operation comprises either an autonomous mode of operation or a manual mode of operation for the vehicle; and
determining the selected Shepard tone for the sound to be provided for the vehicle based on the mode of operation of the vehicle, and wherein a different selected Shepard tone is selected based on whether the mode of operation comprises the autonomous mode of operation versus the manual mode of operation.

17. The system of claim 10, wherein:
the one or more sensors are configured to obtain the sensor data as to a motor torque for the vehicle; and
the processor is further configured to at least facilitate determining the selected Shepard tone for the sound to be provided for the vehicle based on the motor torque for the vehicle.

18. The system of claim 10, wherein:
the one or more sensors are configured to obtain the sensor data as to one or more conditions of caution surrounding the vehicle, including a construction zone, a school zone, or an approaching ambulance; and
the processor is further configured to at least facilitate determining the selected Shepard tone for the sound to be provided for the vehicle based on the one or more conditions of caution surrounding the vehicle.

19. A vehicle comprising:
a body;
a drive system configured to generate movement of the body;
one or more sensors disposed on or within the body and configured to obtain sensor data for the vehicle;
one or more speakers disposed on or within the body and configured to provide a sound for the vehicle; and
a processor that is disposed within the body, that is coupled to the one or more sensors and to the one or more speakers, and that is configured to at least facilitate:
determining a selected Shepard tone for the sound to be provided for the vehicle based on the sensor data; and
providing instructions to the one or more speakers to provide the sound for the vehicle using the selected Shepard tone.

20. The vehicle of claim 19, wherein:
the one or more sensors are configured to obtain the sensor data as to an acceleration of the vehicle; and
the processor is further configured to at least facilitate determining the selected Shepard tone for the sound to be provided for the vehicle based on the acceleration of the vehicle.
